(19) United States
(12) Patent Application Publication
(10) Pub. No.: US 2007/0070425 A1
(43) Pub. Date: Mar. 29, 2007

(54) Object-based sharpening for an image forming device

(75) Inventor: David K. Lane, Stamping Ground, KY (US)

Correspondence Address: John J. McArdle, Jr.;IP Law Department, Dept. 865A/082-01, 740 West New Circle Road, Lexington, KY, 40550, US

(73) Assignee: Lexmark International, Inc.

(21) Appl. No.: 11/239,277

(22) Filed: Sep. 29, 2005

(51) Int. Cl. H04N 1/405

(52) U.S. Cl. 358/3.06; 358/3.27

(57) ABSTRACT

A method and apparatus for sharpening objects formed by an image forming unit. Page objects in print requests may be identified as being one of several different types. Boundaries of the page objects may be eroded according to the type of the page objects, thus defining an eroded boundary. Rectangular objects may be identified by height and width, the boundary eroded by reducing the height and/or width. Character objects may be identified and eroded by performing an AND operation between the original character and a shifted character. Irregular objects may be identified from one or more edge lists and boundaries may be eroded by increasing or decreasing the edge list values. Different halftone screen frequencies may be applied when rendering areas divided by the eroded boundaries. The edges of the objects may be rendered using a higher screen frequency.

### BACKGROUND

Color imaging devices sometimes use halftone screens to combine a finite number of colors and produce, what appears to the human eye, many shades of colors. The halftone process converts different tones of an image into dots of varying size and varying frequency. In general, halftone screens of as few as three colors may suffice to produce a substantial majority of visible colors and brightness levels. For many color imaging devices, these three colors comprise cyan, magenta, and yellow. These three colors are subtractive in that they remove unwanted colors from white light (e.g., a sheet of paper). The yellow layer absorbs blue light, the magenta layer absorbs green light, and the cyan layer absorbs red light. In many cases, a fourth color, black, is added to deepen the dark areas and increase contrast.

In order to print the different color components in a four color process, it is necessary to separate the color layers, with each color layer converted into halftones. In many cases, these monochrome halftone screens are overlaid at different angles to reduce moire effects. The screen frequency that is used for each halftone layer is usually sufficient to produce a continuous tone when viewed by the human eye. In fact, relatively low frequency halftone screens may be used at each color layer considering the natural filtering effect produced by the human visual system. Unfortunately, screens with low frequencies can sometimes produce object edges that appear jagged. Two solutions that may be used to reduce the appearance of rough edges include post-processing boundary transitions after the bitmap is rendered and increasing the halftone screen frequency used during rendering.

Post processing may be used to make the edges of halftoned objects appear more distinct. Established practice achieves this effect by searching for boundary transitions after the bitmap is rendered and enhancing those edges. This approach is imperfect because false boundaries are often detected and modified. Further, actual edges are not always detected. Images pose a particularly significant challenge because they posses many random transitions.

Another technique used to minimize boundary artifacts is to use a higher frequency halftone screen. However, this approach may have the effect of reducing color accuracy while exposing mechanism imperfections. Streaks produced by mechanical jitter may become visible in continuous tone areas of an image. Thus, the known correction techniques may not provide an optimal solution to improving the appearance of edge transitions.

### SUMMARY

Embodiments disclosed herein are directed to methods and apparatuses for sharpening objects formed by an image forming device. Within a print request transmitted to an image forming device, there may be different types of page objects. These page objects may be processed differently according to the object type. For example, the page objects may comprise rectangular objects, character objects, and irregular objects. One or more edges of these objects may be enhanced by applying a different halftone screen frequency near those edges of the object. For instance, one or more edges of an object may be rendered using a higher screen frequency than the remainder of the object. Accordingly, the objects may be partitioned into separate regions with different screen frequencies applied to each. These regions may comprise an edge region around the perimeter of the object and an interior region disposed therein. Boundaries of the page objects may be eroded according to the type of each page object, thus defining an eroded boundary that partitions the object.

For example, rectangular objects may be identified by height and width, with the boundary eroded by reducing the height and/or width of the rectangle. The eroded boundary may be shifted to relocate the eroded boundary. By comparison, character objects may be identified as a bitmap. The outer boundary of the character may be eroded by performing a bitwise AND operation between the original character and a shifted character. Irregular objects may be identified from one or more edge lists. The boundaries of these irregular objects may be eroded by increasing or decreasing the edge list values. For instance, edge list values on the left side of an object may be increased while edge list values on a right side of the object may be decreased.

Edge sharpening may be skipped for image objects defined as bitmaps. The edge sharpening may also be turned on/off or otherwise controlled by user-adjustable parameters.

### BRIEF DESCRIPTION OF THE DRAWINGS

FIG. 1 is a perspective view of one embodiment of a computing system in which the present invention may be implemented;

FIG. 2 is a functional block diagram of one embodiment of a computing system in which the present invention may be implemented;

FIG. 3 is a schematic diagram of the page request process executable by an image forming controller according to one embodiment of the present invention;

FIG. 4 is a functional block diagram of an image forming device according to one embodiment of the present invention;

FIG. 5 is a flowchart diagram of the steps of receiving and processing a request from a host computer according to one embodiment of the present invention;

FIG. 6 is a flowchart diagram of the steps of edge sharpening according to one embodiment of the present invention;

FIG. 7 is a schematic diagram illustrating exemplary halftone screen frequencies applied to interior and edge portions of a rectangular object according to one embodiment of the present invention;

FIGS. 8A-8F are schematic diagrams showing a bitwise AND operation used to form an eroded interior boundary of a character object according to one embodiment of the present invention;

FIGS. 9A-9C are schematic diagrams showing an edge list modification used to form an eroded interior boundary of an irregular object according to one embodiment of the present invention;

FIGS. 10A-10C are schematic diagrams showing an object erosion performed by dividing an irregular shape into a plurality of subsections according to one embodiment of the present invention; and

FIG. 11A-11B is a schematic diagram showing an eroded boundary of a rectangular object according to one embodiment of the present invention; and

FIGS. 12A-12B are schematic diagrams showing an eroded boundary formed by a bitwise AND operation of a character object according to one embodiment of the present invention.

### DETAILED DESCRIPTION

The present application is directed to embodiments of devices and methods for performing edge detail sharpening based in part on a knowledge of objects being reproduced. The process may be applicable to images that are halftoned for reproduction by a color image forming device. The techniques are flexible in that the edge sharpening may be applied to a variety of objects, regardless of shape. For each category of object, the object may be split into an interior portion and an edge portion. In one embodiment, different halftone screens may be applied to the interior and edge portions. For example, a lower screen frequency may be used in the interior portion while a higher screen frequency may be used in the edge portion.

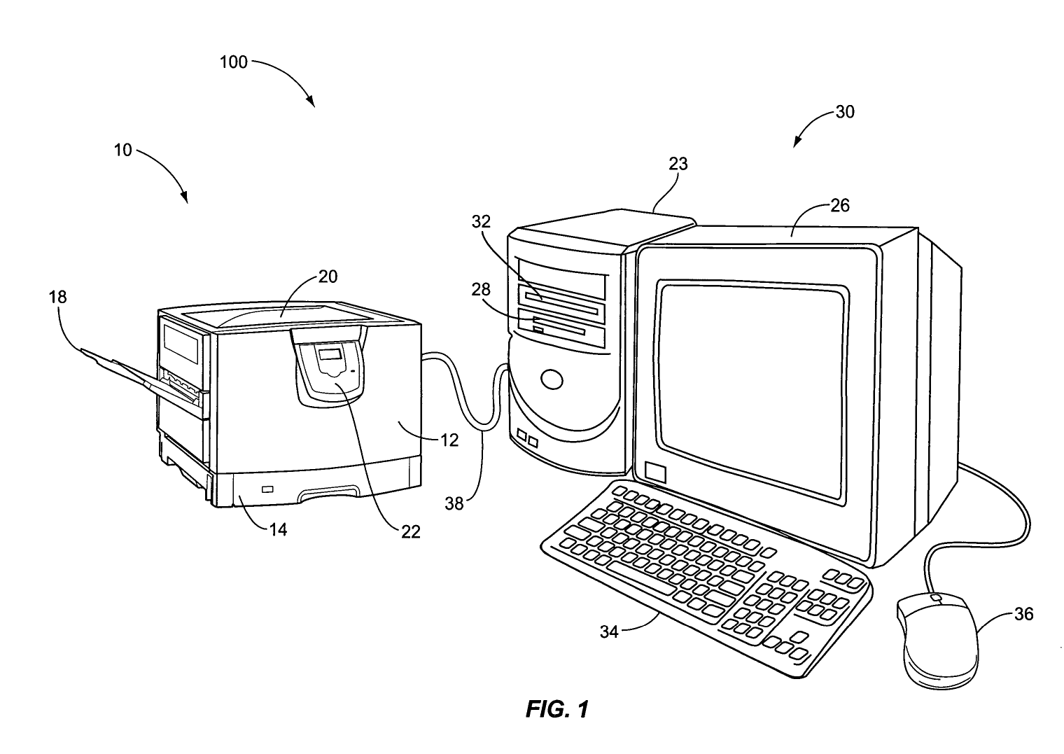

The processing techniques disclosed herein may be implemented in a variety of computer processing systems. For instance, the disclosed processing technique may be executed by a computing system 100 such as that generally illustrated in FIG. 1. The exemplary computing system 100 provided in FIG. 1 depicts one embodiment of a representative image forming device 10, such as a printing device, and a computer 30. A desktop computer 30 is shown, but other conventional computers, including laptop and handheld computers are also contemplated. In the embodiment shown, the image forming device 10 comprises a main body 12, at least one media tray 14 holding a stack of print media, a multipurpose media input tray 18 for feeding envelopes, transparencies and the like, a media output tray 20, and a user interface panel 22. The image forming device 10 may be a printer that uses a conventionally known electrophotographic or ink jet imaging process and may produce color or monochrome images.

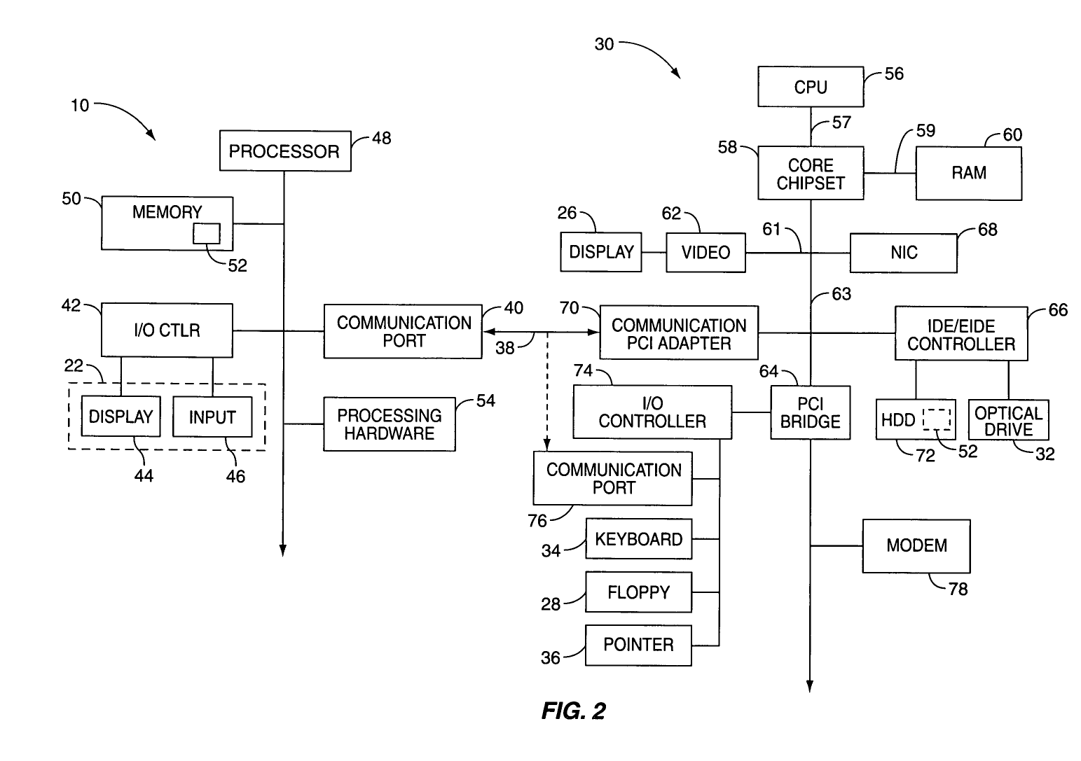

The exemplary computing system 100 shown in FIG. 1 also includes an associated computer 30, which may include a CPU tower 23 having associated internal processors, memory, and circuitry (not shown in FIG. 1, but see FIG. 2) and one or more external media drives. For example, the CPU tower 23 may have a floppy disk drive (FDD) 28 or other magnetic drives and one or more optical drives 32 capable of accessing and writing computer readable or executable data on discs such as CDs or DVDs. The exemplary computer 30 further includes user interface components such as a display 26, a keyboard 34, and a pointing device 36 such as a mouse, trackball, light pen, or, in the case of laptop computers, a touchpad or pointing stick.

An interface cable 38 is also shown in the exemplary computing system 100 of FIG. 1. The interface cable 38 permits one- or two-way communication between the computer 30 and the image forming device 10. When coupled in this manner, the computer 30 may be referred to as a host computer for the image forming device 10. Certain operating characteristics of the image forming device 10 may be controlled by the computer 30 via printer drivers stored on the computer 30. For instance, print jobs originated on the computer 30 may be printed by the image forming device 10 in accordance with resolution and color settings that may be set on the computer 30. Where a two-way communication link is established between the computer 30 and the image forming device 10, information such as printer errors may be transmitted from the image forming device 10 to the computer 30.

With regards to the processing techniques disclosed herein, certain embodiments may permit operator control over image processing to the extent that a user may select whether edge sharpening is performed by the image forming device 10. Similarly, users may be able to modify adjustable parameters, such as halftone screen frequency settings. Accordingly, the user interface components such as the user interface panel 22 of the image forming device 10 and the display 26, keyboard 34, and pointing device 36 of the computer 30 may be used to control various processing parameters. As such, the relationship between these user interface devices and the processing components is more clearly shown in the functional block diagram provided in FIG. 2.

FIG. 2 provides a simplified representation of some of the various functional components of the exemplary image forming device 10 and computer 30. For instance, the image forming device 10 may include the previously mentioned user interface 22, where interaction is controlled with the aid of an I/O controller 42. Thus, the I/O controller 42 generates user-readable graphics at a display 44 and interprets commands entered at a keypad 46. The display 44 may be embodied as an alphanumeric LCD display and keypad 46 may be an alphanumeric keypad. Alternatively, the display and input functions may be implemented with a composite touch screen (not shown) that simultaneously displays relevant information, including images, while accepting user input commands by finger touch or with the use of a stylus pen (not shown).

The image forming device 10 may also be coupled to the computer 30 with an interface cable 38 coupled through a compatible communication port 40, which may comprise a standard parallel printer port or a serial data interface such as USB 1.1, USB 2.0, IEEE-1394 (including, but not limited to 1394a and 1394b) and the like.

The image forming device 10 may also include integrated wired or wireless network interfaces. Therefore, communication port 40 may also represent a network interface, which permits operation of the image forming device 10 as a stand-alone device not expressly requiring a host computer 30 to perform many of the included functions. A wired communication port 40 may comprise a conventionally known RJ-45 connector for connection to a 10/100 LAN or a 1/10 Gigabit Ethernet network. A wireless communication port 40 may comprise an adapter capable of wireless communications with other devices in a peer mode or with a wireless network in an infrastructure mode. Accordingly, the wireless communication port 40 may comprise an adapter conforming to wireless communication standards such as Bluetooth®), 802.11x, 802.15 or other standards known to those skilled in the art.

The image forming device 10 may also include one or more processing circuits 48, system memory 50, which generically encompasses RAM and/or ROM for system operation and code storage as represented by numeral 52. The system memory 50 may suitably comprise a variety of devices known to those skilled in the art such as SDRAM, DDRAM, EEPROM, Flash Memory, and perhaps a fixed hard drive. Those skilled in the art will appreciate and comprehend the advantages and disadvantages of the various memory types for a given application.

Additionally, the image forming device 10 may include dedicated image processing hardware 54, which may be a separate hardware circuit, or may be included as part of other processing hardware. For example, image processing and edge sharpening as disclosed herein may be implemented via stored program instructions for execution by one or more Digital Signal Processors (DSPs), ASICs or other digital processing circuits included in the processing hardware 54. Alternatively, stored program code 52 may be stored in memory 50, with the edge sharpening techniques described herein executed by some combination of processor 48 and processing hardware 54, which may include programmed logic devices such as PLDs and FPGAs. In general, those skilled in the art will comprehend the various combinations of software, firmware, and hardware that may be used to implement the various embodiments described herein.

FIG. 2 also shows functional components of the exemplary computer 30, which comprises a central processing unit (“CPU”) 56, core logic chipset 58, system random access memory (“RAM”) 60, a video graphics controller 62 coupled to the aforementioned video display 26, a PCI bus bridge 64, and an IDE/EIDE controller 66. The single CPU block 56 may be implemented as a plurality of CPUs 56 in a symmetric or asymmetric multi-processor configuration.

In the exemplary computer 30 shown, the CPU 56 is connected to the core logic chipset 58 through a host bus 57. The system RAM 60 is connected to the core logic chipset 58 through a memory bus 59. The video graphics controller 62 is connected to the core logic chipset 58 through an AGP bus 61 or the primary PCI bus 63. The PCI bridge 64 and IDE/EIDE controller 66 are connected to the core logic chipset 58 through the primary PCI bus 63. A hard disk drive 72 and the optical drive 32 discussed above are coupled to the IDE/EIDE controller 66. Also connected to the PCI bus 63 are a network interface card (“NIC”) 68, such as an Ethernet card, and a PCI adapter 70 used for communication with the image forming device 10 or other peripheral device. Thus, PCI adapter 70 may be a complementary adapter conforming to the same or similar protocol as communication port 40 on the image forming device 10. As indicated above, PCI adapter 70 may be implemented as a USB or IEEE 1394 adapter. The PCI adapter 70 and the NIC 68 may plug into PCI connectors on the computer 30 motherboard (not illustrated). The PCI bridge 64 connects over an EISA/ISA bus or other legacy bus 65 to a fax/data modem 78 and an input-output controller 74, which interfaces with the aforementioned keyboard 34, pointing device 36, floppy disk drive (“FDD”) 28, and optionally a communication port such as a parallel printer port 76. As discussed above, a one-way communication link may be established between the computer 30 and the image forming device 10 or other printing device through a cable interface indicated by dashed lines in FIG. 2.

Relevant to the edge sharpening techniques disclosed herein, digital files, images, and documents may be read from a number of sources in the computing system 100 shown. Files to be printed may be stored on fixed or portable media and accessible from the HDD 72, optical drive 32, floppy drive 28, or accessed from a network by NIC 68 or modem 78. Further, as mentioned above, the various embodiments of the edge sharpening techniques may be fully or partially implemented as a device driver, program code 52, or software that is stored in memory 50, on HDD 72, on optical discs readable by optical disc drive 32, on floppy disks readable by floppy drive 28, or from a network accessible by NIC 68 or modem 78. Furthermore, since the edge sharpening technique may be implemented before image rasterization, some or all of sharpening process may be performed by the CPU 56 of the computer 30 that transmits a page description to the image forming device 10. Those skilled in the art of computers and network architectures will comprehend additional structures and methods of implementing the techniques disclosed herein.

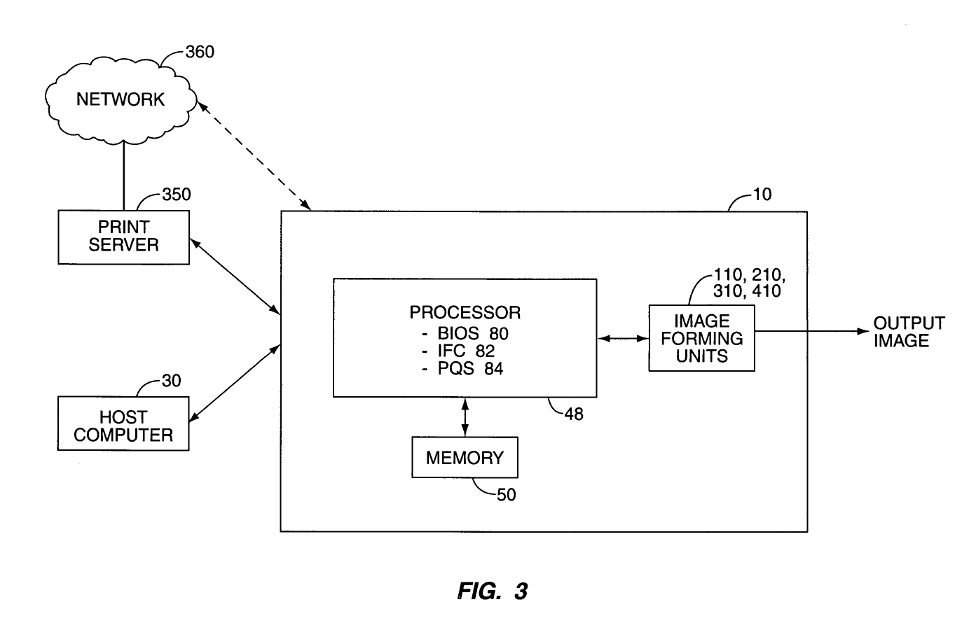

FIG. 3 shows a simplified diagram outlining the general process by which an image forming device 10 receives and outputs image data. In this embodiment, a printing network comprises a print server 300, a host computer 30 and an image forming device 10. The image forming device 10 receives print requests from computers coupled to the image forming device 10. The network 310 may be local or remote. The request may come from a host computer 30 or may come from a network 310, such as a LAN. Network requests may be processed by a print server 300 acting as a host computer before delivery to the image forming device 10. Alternatively, the image forming device 10 may be a stand-alone device coupled directly to the network 310.

The print request includes page description language data for producing the output image. The data may include page layout information, including the position of the objects on the page, font size, style, colors, image bitmaps, and other scaling operations. One embodiment of a page description language is POSTSCRIPT by Adobe Systems, Incorporated. In one embodiment as illustrated in FIG. 3, the processor 48 executes several fundamental functions, including: a basic input/output system (BIOS) 80 managing an engine interface and input/output drivers; an image forming controller (IFC) 82 having language processors and graphics subsystem library; and a page queuing system (PQS) 84. As described above, memory 50 may be associated with the processor 48 for storing page formations, for buffering print data, and for storing program instructions to perform the edge sharpening techniques disclosed herein. In one embodiment, character bitmaps are saved in memory 50 for use on future print requests. Saving the bitmaps in memory 50 speeds processing time as the IFC 82 does not calculate new bitmaps, but rather recalls repetitive bitmaps that are the same as those previously calculated and saved. One skilled in the art will understand that there are various embodiments for the IFC 82 which are to be included herein and the description and illustration of FIG. 3 are included as an example of one embodiment.

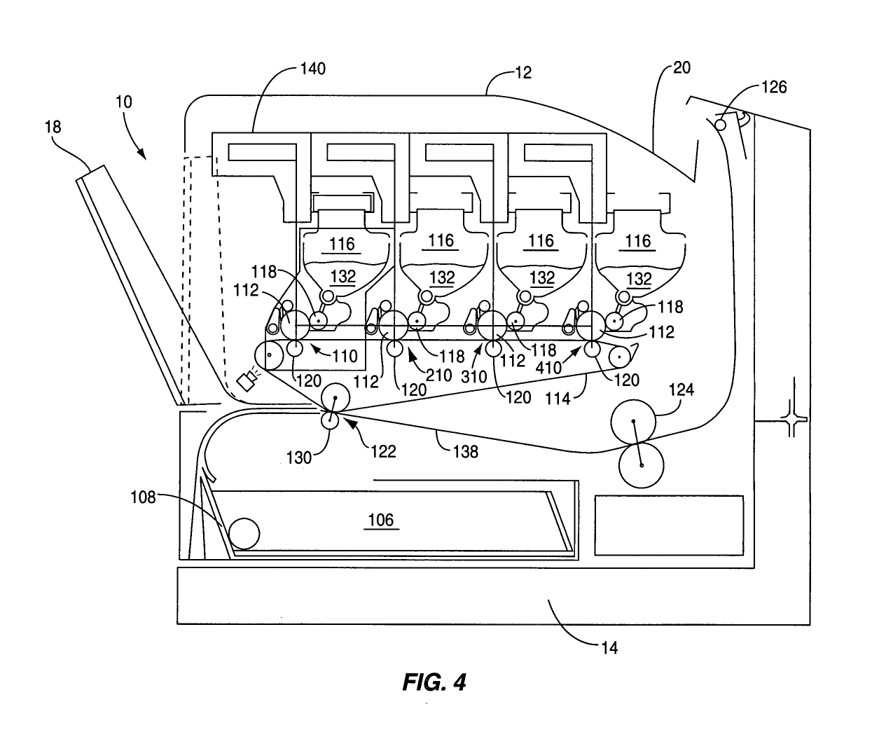

The IFC 82 receives the page description language and decomposes the image data into smaller objects and further renders the image as a series of monochrome, halftone bitmaps that are delivered for production by one or more image forming units 110, 210, 310, 410. The individual color images are combined as shown in the exemplary image forming device 10 provided in FIG. 4.

FIG. 4 depicts a representative dual-transfer color image forming device 10. Similar to the representation shown in FIG. 1, the image forming device 10 comprises a housing 12, a media tray 14, a multipurpose tray 18, and an output tray 20. The media tray 14 includes a main stack of media sheets 106 and a sheet pick mechanism 108. The media tray 14 may be removable for refilling and may be located in a lower section of the device 10.

Within the image forming device housing 12, the image forming device 10 may include one or more image forming units 110, 210, 310, 410, each associated with a single color. Each image forming unit 110, 210, 310, 410 may include removable developer cartridges 116, photoconductive units 112, developer rollers 118 and corresponding transfer rollers 120. The representative image forming device 10 also includes an intermediate transfer mechanism (ITM) belt 114, a fuser 124, and exit rollers 126, as well as various additional rollers, actuators, sensors, optics, and electronics (not shown) as are conventionally known in the image forming device arts, and which are not further explicated herein. Additionally, the image forming device 100 includes one or more controllers, microprocessors, DSPs, or other stored-program processors and associated computer memory, data transfer circuits, and/or other peripherals (not shown in FIG. 4, but see FIG. 2) that provide overall control of the image formation process.

Each developer cartridge 116 may include a reservoir containing toner 132 and a developer roller 118, in addition to various rollers, paddles and other elements (not shown). Each developer roller 118 is adjacent to a corresponding photoconductive unit 112, with the developer roller 118 developing a latent image on the surface of the photoconductive unit 112 by supplying toner 132. In various alternative embodiments, the photoconductive unit 112 may be integrated into the developer cartridge 116, may be fixed in the image forming device housing 12, or may be disposed in a removable photoconductor cartridge (not shown). In a typical color image forming device, three or four colors of toner—cyan, yellow, magenta, and optionally black—are applied successively (and not necessarily in that order) to a print media sheet 106 to create a color image. Correspondingly, FIG. 4 depicts four image forming units 110, 210, 310, 410. In a monochrome printer, only one forming unit 110 may be present.

The operation of the image forming device 10 is conventionally known. Upon command from control electronics, a single media sheet 106 is “picked,” or selected, from either the primary media tray 14 or the multipurpose tray 18 while the ITM belt 114 moves successively past the image forming units 110, 210, 310, 410. As described above, at each photoconductive unit 112, a latent image is formed thereon by optical projection from an optical device 140. The latent image is developed by applying toner to the photoconductive unit 112 from the corresponding developer roller 118. The toner is subsequently deposited on the ITM belt 114 as it is conveyed past the photoconductive unit 112 by operation of a transfer voltage applied by the transfer roller 120. As the ITM belt 114 passes by each successive image forming unit 110, 210, 310, 410, each color is layered onto the ITM belt 114 to form a composite image. The media sheet 106 is fed to a secondary transfer nip 122 where the image is transferred from the ITM belt 114 to the media sheet 106 with the aid of a secondary transfer roller 130. The media sheet proceeds from the secondary transfer nip 122 along media path 138. The toner is thermally fused to the media sheet 106 by the fuser 124, and the sheet 106 then passes through exit rollers 126, to land facedown in the output tray 20 formed on the exterior of the image forming device housing 12.

In one embodiment of the edge sharpening procedure, processing is performed during the rasterization process by the IFC 82 shown in FIG. 3. The IFC 82 identifies page objects as being from one of a variety of different categories. The halftone images for each of the page objects is then generated based on specific procedures for the category. Those halftone objects are reproduced by the image forming units 110, 210, 310, 410 in the manner just described to create a full color image. In one embodiment, the page object categories include identifying the page objects as rectangles, characters, and non-rectangular shapes. Page objects may further be identified as being of a type that edge sharpening is not to be performed, such as a bitmap or raster image.

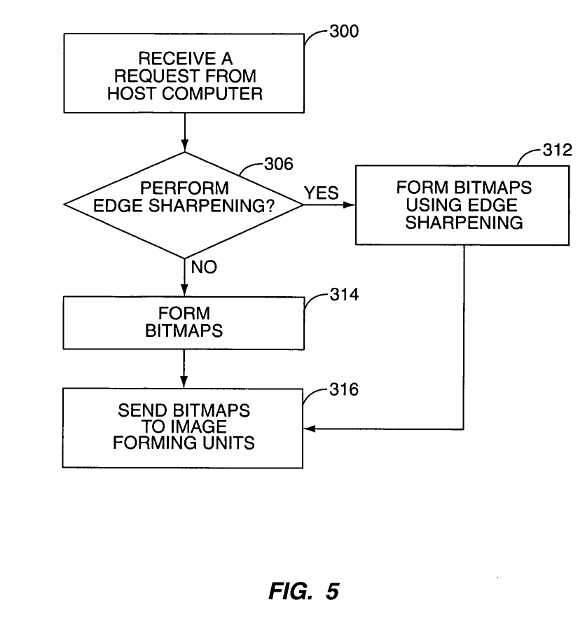

Accordingly, the process outlined in FIG. 5 reveals a top-level decision to determine whether the IFC 82 implements the edge sharpening. The edge sharpening function may be a user-selectable feature that is controlled by selection through a user-interface panel 22 on the image forming device or alternatively through driver software running on a host computer 30. The process starts when a page description is delivered to the BIOS 80 of the processor 48 (step 300). The data is routed to the IFC 82 to determine whether edge sharpening is necessary (step 306). If edge sharpening is required (step 312), the data is converted into halftone images, with object information used to modify object edges. If edge sharpening is not required (step 314), the halftone images are formed without edge sharpening. In both embodiments, the raster image data is forwarded for production by the image forming units 110, 210, 310, 410 for image formation (step 316).

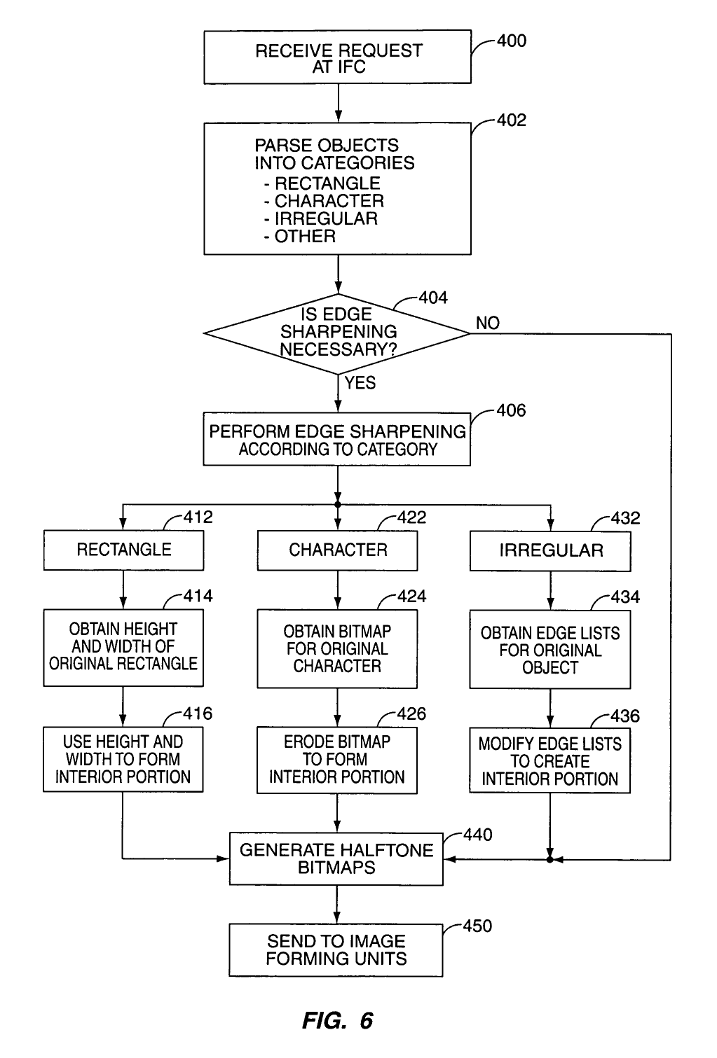

When edge sharpening is turned on, FIG. 6 illustrates the steps of edge sharpening for different categories of page objects according to one embodiment of the present invention. The method starts when the page description is received at the IFC 82 (step 400). The page objects are parsed and categorized (step 402). In one embodiment, each page object is identified as being a rectangle, a character, an irregular object, or other. The IFC 82 determines whether edge sharpening is necessary (step 404) based in part on the object type. In one embodiment, objects that are not classified as being a rectangle, a character, or an irregular object are not processed using the edge sharpening function. In yet another embodiment, the object is a photograph and edge sharpening is not performed. These objects are rendered (step 440) without edge sharpening and sent to the image forming units 110, 210, 310, 410 (step 450). Once the page objects are categorized, edge sharpening is performed according to the category of the page object (step 406).

The objects that are parsed in step 402 for edge sharpening may be divided into an interior portion and an edge portion. Different screen frequencies may then be applied to these separate portions. Initially, however, the edge sharpening algorithm creates the interior portion as a duplicate of the original object that is eroded or reduced in size. For instance, rectangles may be identified by the height and width dimensions (steps 412 and 414). The dimensions are used as a template for forming the halftone bitmap for the interior portion (step 416). In one embodiment, the dimensions of the interior portion are the same as the height and width dimensions of the original object. In another embodiment, the dimensions of the interior portion are decreased to dimensions smaller than the original object. Decreasing the dimensions may include decreasing the height, decreasing the width, or decreasing both. In one embodiment, it is necessary to translate the height and width to re-center the interior portion relative to the position of the original object.

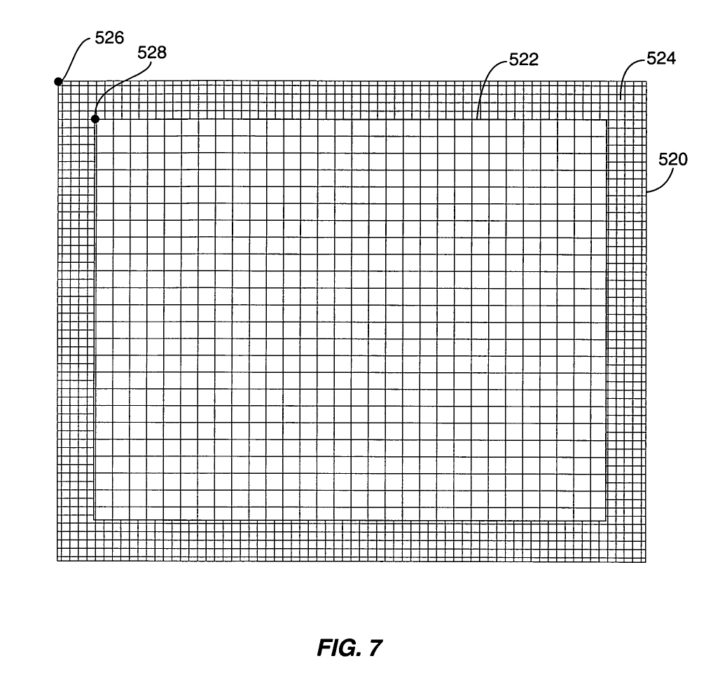

One embodiment of decreasing both the height and the width of the interior portion is illustrated in FIG. 7. The original rectangle 520 is larger than the interior portion 522. The area representing the difference between these two rectangles 520, 522 may be referred to as the edge portion 524. In one embodiment, the halftone screen frequency applied to the interior portion 522 and the edge portions 524 are different. In one embodiment, the halftone screen frequency applied to the edge portion 524 is larger than the halftone screen frequency applied to the interior portion 522. For example, a halftone screen frequency of 72 lines per inch may be applied to the interior portion 522 while a larger frequency of 96 or higher may be applied to the edge portion 524.

The amount of reduction of the interior portion 522 may vary depending upon the specific requirements of the print request and the mechanics of the image forming device 10. In one embodiment, the dimensions of the interior portion 522 are reduced 2 pels on each edge. The decreased interior portion 522 may be re-centered relative to the original object 520 by translating the origin from an initial position 526 to a new position 528. The origin may be a point on the surface of the object 520.

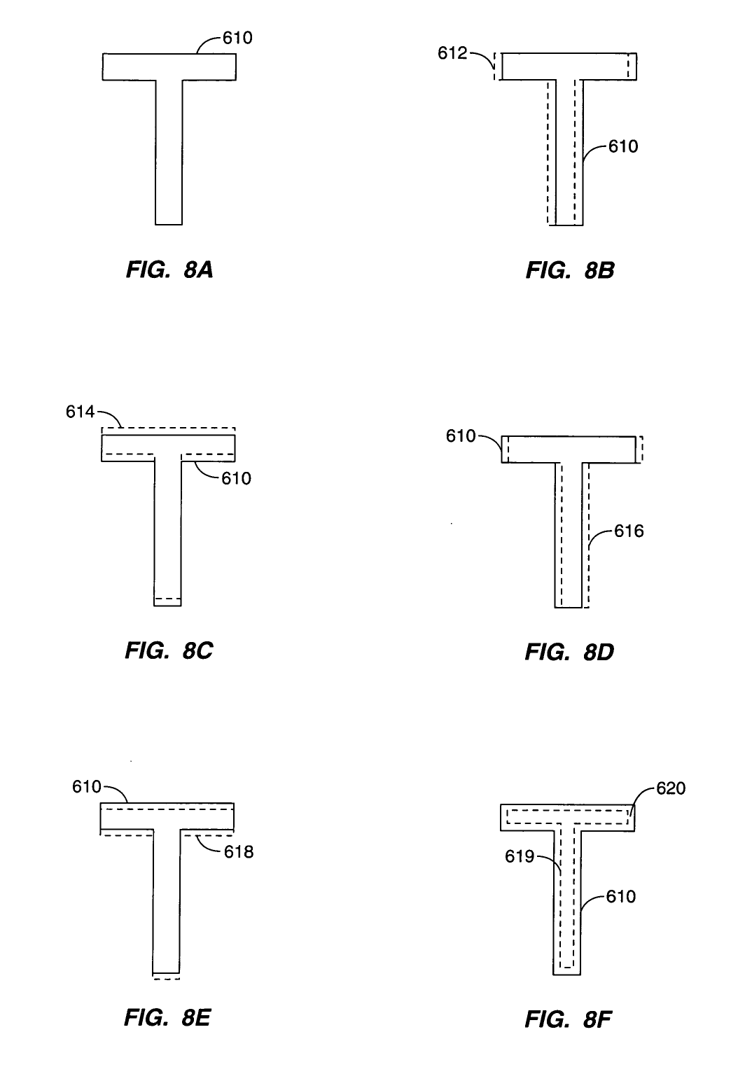

Referring to FIG. 6, character objects are another identified category (step 422). Characters may include alphanumeric figures, symbols, punctuation marks, and other repetitively formed objects. A bitmap of the character to be sharpened is obtained from, generated from, or selected by the page description sent to the IFC 82 (step 424). As discussed above, character fonts or bitmaps may be saved in memory 50 for use on print requests. Bitmaps for the interior portion of a character may be formed by eroding the original bitmap (step 426). In one embodiment, at least one pixel is removed from the original bitmap to form the interior portion. In another embodiment, a number of pixels are removed from the original bitmap. In yet another embodiment, a bitwise AND operation is performed based on the original bitmap. FIGS. 8A through 8F illustrate one embodiment of the bitwise AND operation creating the eroded interior portion 619 from the original bitmap 610. FIG. 8A illustrates the original bitmap for the character “T” 610. In the example shown, the original bitmap 610 is shifted a number of pels in each direction. The shifted bitmap is illustrated as 612 in FIG. 8B (left), 614 in FIG. 8C (upward), 616 in FIG. 8D (right), and 618 in FIG. 8E (downward). In the embodiment illustrated, the bitmap is moved two pels in each direction. The results of each of the movements are combined in a bitwise AND operation to form the bitmap for the interior portion 619. The bitmaps for the original object 610, the interior portion 619, and the resulting edge portion 620 are illustrated in FIG. 8F. The amount of movement and directions of movement may vary depending upon the desired results. Further, different halftone screen frequencies may be applied to the interior portion 619 and edge portion 620 as discussed above. In addition, the original character bitmaps 610 and the eroded bitmap defining the interior portion 619 may be stored in memory 50 for future print jobs.

Referring to FIG. 6, irregular objects are another identified category (step 432). Irregular objects are defined by edge lists within the page description. In one embodiment, the edge lists include an array of first coordinates and an array of second coordinates that define the shape of the irregular object. In one embodiment, the first and second coordinates are left and right object limits along a scan line. In one embodiment, the bitmap of the original object is formed by the edge list (step 434).

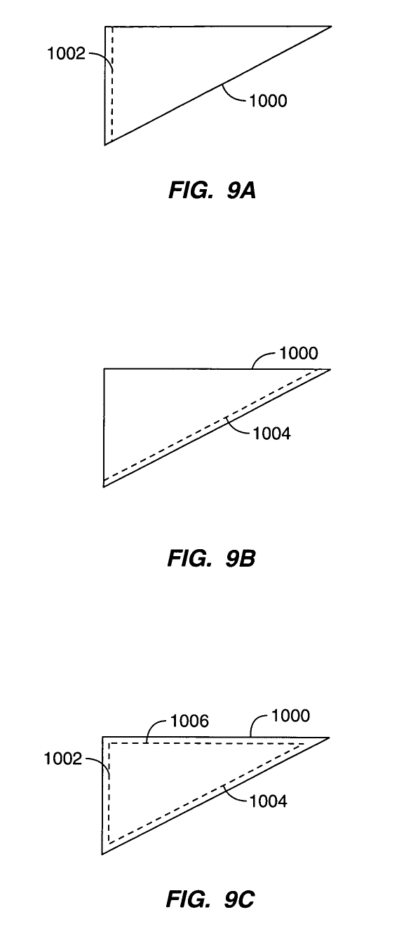

The bitmaps for the interior portions of irregular objects are formed by decreasing the original edge lists (step 436). In one embodiment, the first edge list 1002 is modified as illustrated in FIG. 9A (i.e., the left edge list is increased or moved to the right in the view shown). In another embodiment, and second edge list 1004 is modified as illustrated in FIG. 9B (i.e., the right edge list is decreased or moved to the left in the view shown). In another embodiment, both edge lists 1002, 1004 are modified as illustrated in FIG. 9C (i.e., the left edge list is increased and the right edge list is decreased). The remaining edges such as the top edge 1006 may also be modified. In one embodiment, a first predetermined number of members from each of the first and second arrays are discarded thereby moving the top edge a predetermined amount. Likewise, a predetermined number of last coordinates within each array may be discarded to move the bottom edge a predetermined amount. In another embodiment, the top and bottom edges are replicated in a different position relative to the original shape and the edge lists are modified accordingly.

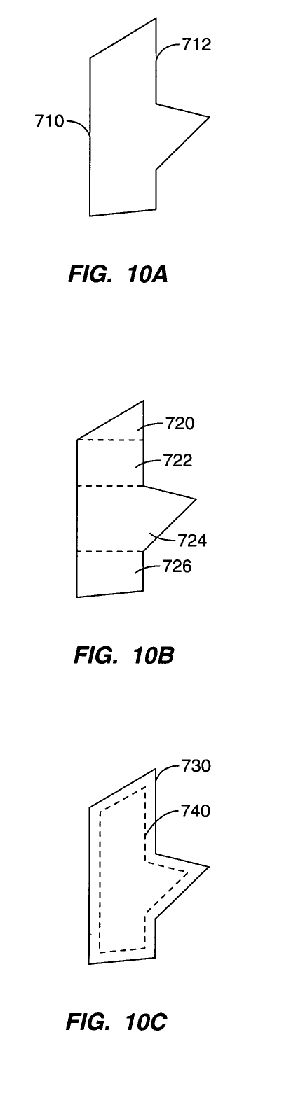

In another embodiment of forming eroded interior portions, an irregular shape 710, such as that illustrated in FIG. 10A, may be divided into subsections as illustrated in FIG. 10B. Subsections 722 and 726 are rectangular and are eroded in a like manner as previously described. Subsections 720 and 724 remain irregular and are eroded by determining the subsection edge lists and constructing an eroded edge list that fits within the original edge list. FIGS. 10B and 10C illustrate one embodiment of the process for forming the bitmap for the interior portions using modified edge lists 740 for each of the subsections 720, 722, 724, 726. Certain upper and lower boundaries of the modified edge lists 740 may be left intact such that the eroded edge lists 740 comprise a contiguous section as illustrated in FIG. 10C. In another embodiment, the internal top and bottom edge lists are modified such that eroded subsections 720, 722, 724, 726 form distinct eroded bitmaps.

Returning to FIG. 6, once the boundaries for the interior and edge portions of each object are calculated, halftone bitmaps are generated (step 440) using appropriate screen frequencies. These bitmaps are forwarded to the image forming apparatus 110, 210, 310, 410 (step 450) for producing the output image as described above.

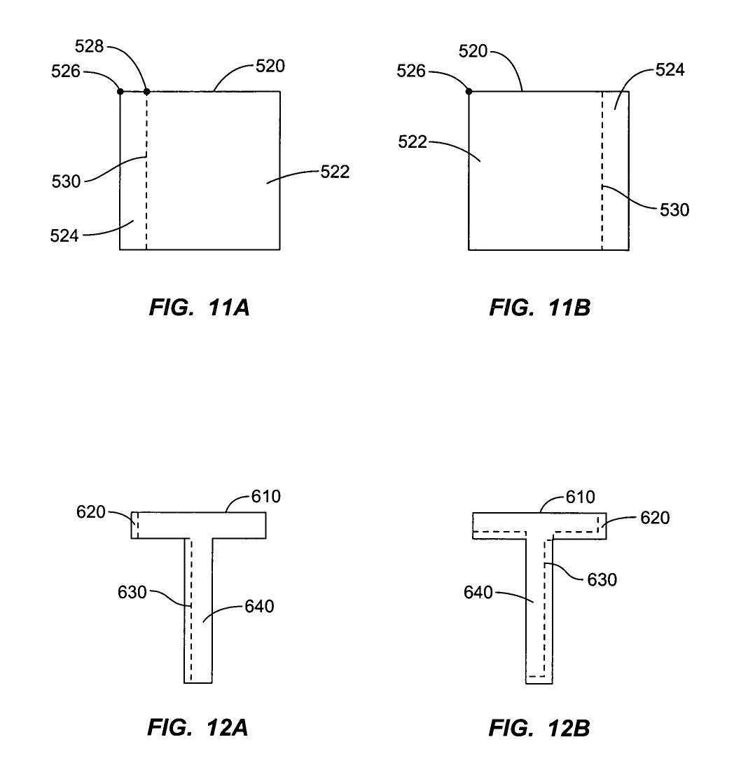

The various erosion processes described above have generated an eroded boundary that separates an interior portion from an edge portion of an object. However, there may be instances where less than all edges of an object need to be sharpened. For instance, objects may fade in color from one side of the object to the other with edge sharpening indicated only at the darkest edges. The above techniques may still be applied in such cases. For example, the rectangular shape from FIG. 7 is reproduced in FIGS. 11A-11B. However, in the latter Figures, an eroded boundary 530 does not extend around the full perimeter of the object 520. In the examples shown, the eroded boundary 530 is generated by adjusting the known width of object 520. In the example shown in FIG. 11A, the width is decreased and the eroded boundary 530 is shifted to the right by the amount of reduction. In other words, the eroded boundary 530 is shifted from origin 526 to origin 528. This shifted boundary 530 divides the original object 520 into a first portion 524 and a second portion 522. In this particular case, the first portion 524 is an edge portion disposed near the left edge of the object 520. The second portion 524 is merely the remaining portion of the original object 520.

In the example shown in FIG. 11B, the width is decreased by the same amount, but the position of the eroded boundary is maintained. Thus, the eroded boundary 530 creates a first edge portion 524 located on the right side of the object 520 while the remaining portion 522 is on the left side of the object 520. This process may be extended to include two or more edges of a rectangle object 520 through some combination of decreasing height and width and relocating the eroded boundary 530 accordingly.

In another embodiment shown in FIGS. 12A-12B, a similar process to that shown in FIGS. 11A-11B is performed on a character object 610. The process portrayed in FIGS. 8A-8F produced an interior portion 619 and an edge portion 620 of the character “T.” This edge portion 620 extends around the full perimeter of the character object 610 (see FIG. 8F). In cases where less than all edges of a character need to be sharpened, the AND operation may be shortened to produce an eroded boundary at certain edges. For example, the eroded boundary 630 shown in FIG. 12A is produced through one bitwise AND calculation between the original object 610 and the shifted bitmap 616 as shown in FIG. 8D. The eroded boundary 630 thus divides the original character 610 into a first portion 620 and a second portion 640. The first portion 620, which is located near the left edge of the original character 610, may be rendered with a high frequency halftone screen. The remaining second portion 640 may be rendered with a lower frequency halftone screen.

Similarly, the eroded boundary 630 shown in FIG. 12B is produced through two bitwise AND calculations between the original object 610 and the shifted bitmaps 612 and 614 as shown in FIGS. 8B and 8C, respectively. The eroded boundary 630 thus divides the original character 610 into a first portion 620 and a second portion 640. The first portion 620, which is located near the right and bottom edges of the original character 610, may be rendered with a high frequency halftone screen. The remaining second portion 640 may be rendered with a lower frequency halftone screen.

In another embodiment, characters that are defined in the page description by their outlines may be categorized as an irregular shape. One example of this occurrence is when the size of a character exceeds a predetermined amount. The bitmaps for the characters are determined in accordance with the irregular shape calculations and the character may be subdivided into subsections.

Further calculations may be performed for each of the object categories. The edge list for an object may be analyzed to determine whether the object comprises a finite area. If the area is not finite, edge sharpening may not be performed. In another embodiment, edge sharpening may not be performed if object erosion results in the interior portion being reduced to zero.

The present invention may be carried out in other specific ways than those herein set forth without departing from the scope and essential characteristics of the invention. For example, while embodiments described above have contemplated dividing an original object into an interior portion and an edge portion, it is also possible to create multiple portions near the edge of an object to implement screen frequency gradients. In other words, three or more halftone screen frequencies may be used to reduce noticeable transitions between the regions. Each portion may be eroded by differing amounts, with different screen frequencies applied to each portion.

The object based edge sharpening may be incorporated in a variety of image forming devices including, for example, printers, fax machines, copiers, and multi-functional machines including vertical and horizontal architectures as are known in the art of electrophotographic reproduction. The present embodiments are, therefore, to be considered in all respects as illustrative and not restrictive, and all changes coming within the meaning and equivalency range of the appended claims are intended to be embraced therein.

What is claimed is:

1. A method of sharpening objects formed by an image forming device comprising:
receiving a print request comprising a page object;
eroding one or more boundaries of the page object, thereby defining a first portion of the object and a second portion of the object;
applying a first halftone screen when rendering areas within the first portion of the object; and
applying a second halftone screen that is different than the first halftone screen when rendering areas within the second portion of the object.

2. The method of claim 1 further comprising identifying a category of the page object as being one of several different types; determining that edge sharpening is necessary for the page object; and performing edge sharpening according to the category of the page object.

3. The method of claim 2 wherein identifying a category of the page object comprises identifying a rectangle by a height dimension and a width dimension of the rectangle object.

4. The method of claim 2 wherein identifying a category of the page object comprises identifying a character bitmap.

5. The method of claim 2 wherein identifying a category of the page object comprises identifying an irregular object from one or more edge lists.

6. The method of claim 1 wherein the first portion of the object is an interior portion of the object and the second portion of the object is an edge portion of the object.

7. A method of sharpening objects formed by an image forming device comprising:
determining a boundary of a page object;
generating an eroded bitmap of the page object;
rendering the eroded bitmap of the object using a first halftone screen; and
rendering portions of the object outside the eroded bitmap using a second halftone screen that is different than the first halftone screen.

8. The method of claim 7 wherein the first halftone screen is characterized by a screen frequency that is lower than that of the second halftone screen.

9. The method of claim 7 wherein generating an eroded bitmap of said page objects comprises shifting an original bitmap of the page object by at least one pixel and performing a bitwise AND operation between the original bitmap and a shifted bitmap to remove at least one pixel not contained in an overlap between the original bitmap and the shifted bitmap.

10. The method of claim 7 wherein generating an eroded bitmap of said page objects comprises reducing one of the height and width of a rectangular page object.

11. The method of claim 10 further comprising shifting the eroded bitmap by at least one pixel to relocate the eroded bitmap.

12. The method of claim 7 wherein generating an eroded bitmap of said page objects comprises modifying edge lists of an irregular page object.

13. A method of sharpening objects formed by an image forming device comprising:
receiving a print request describing a plurality of page objects;
identifying a category of the page objects as being one of several different types;
eroding one or more boundaries of the page objects according to the type of the page objects;
applying a first halftone screen when rendering areas within the eroded boundaries of the object; and
applying a second halftone screen when rendering areas outside of the eroded boundaries of the object.

14. The method of claim 13 wherein identifying a category of the page object comprises identifying a rectangle by a height dimension and a width dimension of the rectangle object.

15. The method of claim 13 wherein identifying a category of the page object comprises identifying a character bitmap.

16. The method of claim 13 wherein identifying a category of the page object comprises identifying an irregular object from one or more edge lists.

17. A computer readable medium which stores computer-executable process steps for sharpening objects of a printed page, said computer-executable process steps causing a computer to perform the steps of:
receiving a print request comprising a page object;
shifting one or more boundaries of the page object to define an eroded boundary, the eroded boundary partitioning the page object into an interior portion and an edge portion;
applying a first halftone screen when rendering areas within the interior portion of the object; and
applying a second halftone screen when rendering areas within the edge portion of the object.

18. The computer readable medium of claim 17 further comprising:
identifying the page object as belonging to one of several different categories; and
shifting one or more boundaries of the page object according to the category of the page object.

19. The computer readable medium of claim 18 wherein identifying the page object as belonging to one of several different categories comprises identifying a rectangle by a height dimension and a width dimension of the object.

20. The computer readable medium of claim 19 wherein shifting one or more boundaries of the page object comprises reducing the height dimension and width dimension of the rectangle page object.

21. The computer readable medium of claim 20 further comprising shifting the eroded boundary by at least one pixel to relocate the eroded boundary.

22. The computer readable medium of claim 18 wherein identifying the page object as belonging to one of several different categories comprises identifying a character bitmap.

23. The computer readable medium of claim 22 wherein shifting one or more boundaries of the page object comprises shifting an original bitmap of the character by at least one pixel and performing a bitwise AND operation between the original bitmap and a shifted bitmap to remove at least one pixel not contained in an overlap between the original bitmap and the shifted bitmap.

24. The computer readable medium of claim 18 wherein identifying the page object as belonging to one of several different categories comprises identifying an irregular object from one or more edge lists.

25. The computer readable medium of claim 24 wherein shifting one or more boundaries of the page object comprises modifying edge lists of an irregular page object.
